(19) United States
(12) Patent Application Publication
(10) Pub. No.: US 2009/0002692 A1
(43) Pub. Date: Jan. 1, 2009

(54) Method of Measuring the Laser Power of a Forward Multiple Laser Beam in a Multibeam Optical Scanning System

(75) Inventors: Floris Maria Hermansz Crompvoets, Eindhoven (NL); Alexander Marc Van Der Lee, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/097,977

(22) PCT Filed: Dec. 12, 2006
(86) PCT No.: PCT/IB06/54770

§ 371 Date: Jun. 18, 2008

(30) Foreign Application Priority Data
Dec. 21, 2005 (EP) 05112582.1

(51) Int. Cl. G01J 1/42

(52) U.S. Cl. 356/222

(57) ABSTRACT

A method for measuring the laser power of a forward multiple beam generated by a laser diode array comprising at least two laser diodes, the method comprising a generation step, comprising generating the forward multiple beam; a separation step, comprising separating at least part of the forward multiple beam into individual beams (31, 32, 300, 301, 302, 303), the number of individual beams being equal to the number of laser diodes in the laser diode array, the arrangement being such that each individual beam comprises light originating from a single laser diode and a measurement step, comprising measuring the laser power of each individual beam by means of photo detectors (121, 122, 125, 126, 127, 128). The separation may be performed in space, by means of an imaging lens or making use of vignetting of the collimator lens, or in time.

### FIELD OF THE INVENTION

The present invention relates generally to method for measuring the laser power of a forward multiple beam generated by a laser diode array comprising at least two laser diodes. The application also relates to a method for automatic power control for the laser power of a forward multiple beam generated by a laser diode array comprising at least two laser diodes and a recording method. The application also relates to an optical pick-up unit and a multi-beam optical scanning device.

### BACKGROUND OF THE INVENTION

An optical scanning apparatus scans an optical disc by means of a scanning radiation beam, usually a laser beam generated by a laser diode, the scanning radiation beam being focused in a small spot onto the optical disc. Scanning an optical disc is to be understood as reading from and/or writing onto an information layer of the optical disc.

Presently, the maximum rate at which the data is read and/or written is ultimately limited by the servo control and the mechanical stability of the optical disc. In order to increase the data rate further, multiple optical radiation beams may be used to simultaneously read and write data on multiple tracks. The number of optical radiation beams gives an additional multiplication of the data rate. An increase in the number of scanning radiation beams can be obtained by increasing the number of heads of the optical scanning apparatus. However there arise serious problems in using multiple heads related to complicated controls, increase in size and manufacturing costs. A solution is using a semiconductor laser comprising a plurality of individually controllable laser diodes, able to generate a plurality of scanning radiation beams wherein the separate controls over each scanning radiation beam are available.

Rewritable optical discs usually make use of phase change materials as the information layer, wherein said layer has an amorphous or crystalline state, depending on the amount of heat applied to the optical disc when recording. For recording onto such optical discs making use of phase change materials it is essential to have a good control of the power of the scanning radiation beam in order to be able to record the data on the optical disc accurately. It is known that in the case of laser diodes, the relationship between the driving current and the output radiation power varies for example dependent on the ambient temperature and over the lapse of time since the activation of the optical scanning apparatus. Consequently, when accurate power adjustment is necessary, as in the case of recording optical discs comprising phase change materials, optical scanning apparatuses using a single scanning radiation beam are equipped with an automated power control loop (APC) to keep the output radiation power constant.

However, using a semiconductor laser comprising a plurality of individually controllable laser diodes has the drawback that there exists a (thermal) cross-talk between these laser diodes leading to offsets in the output powers. For instance when one laser of the multi-diode semiconductor laser is operating at a high laser output power for writing and a second laser of the multi-diode semiconductor laser is switched on, then the output power of the first laser diode changes. This change in power is unwanted during recording as it affects the quality of the recording, for example by increasing the jitter by affecting the length of the marks. Consequently it is desirable to have a automatic power control that is compatible to usage in a multi-beam optical scanning system.

Japanese Patent Application No 03-309105 discloses a method for performing automatic power control for a multi-beam laser, wherein each laser emits a forward beam and a backward beam, a condensing lens being provided in the path of the backward beam for imaging the backward beam onto a corresponding array of photo detectors.

### SUMMARY OF THE INVENTION

It is an object of the invention to provide a method for measuring the laser power of a forward multiple beam generated by a laser diode array comprising at least two laser diodes. This object is achieved by a method according to the invention characterized as recited in claim 1. When recording onto (re)writable optical disc making use of phase change materials, requires high laser powers. Consequently, the reflectivity of the backside of the laser diode is close to 1 while the reflectivity of the front side of the laser diode is much lower, usually in the order of 10-50%, such that the output laser power is mostly in the forward beam. Part of the forward beam will be reflected backwards by the optics or the optical disc and as the laser diode itself is transparent to light, it may couple to cavity and or exit the backside of the laser. The backward propagation beam will comprise both the backward beam and part of the forward beam that is reflected, and consequently cannot be used anymore for an accurate calibration of laser power, as it will fluctuate depending on the focusing conditions. Hence the method as disclosed in Japanese Patent Application No 03-309105 cannot be used for measuring the laser power of a forward multiple beam. When measuring laser power of a forward multiple beam, a problem arises due to the fact that the multiple beams are almost always overlapping in the conventional light path and therefore it is not straightforward to measure the output power of each laser independently.

A method according to the invention for measuring the laser power of a forward multiple beam generated by a laser diode array comprising at least two laser diodes, comprising steps of generating the forward multiple beam; separating at least part of the forward multiple beam into individual beams, the number of individual beams being equal to the number of laser diodes in the laser diode array, the arrangement being such that each individual beam comprises light originating from a single laser diode and the step of measuring the laser power of the each individual beam. By separating the forward multiple beam into separate beams it is possible to measure the laser power of an individual beam.

In an embodiment of the method, the separation step comprises spatial separation of the individual beams. In an advantageous embodiment the method further comprises passing the forward multiple beam through a collimator lens, the collimator lens being placed such that the laser diode array is substantially in the focal point of the collimator lens, and measuring the laser power of each individual beam by means of a photo detector placed at the edge of the forward multiple beam in a vignetting region after the collimation lens where the individual beams do not overlap, each photo detector thereby receiving light from a single laser diode. Said embodiment carries the advantage that no further optical elements are required in an optical pick-up unit according to the invention compared to known designs, consequently maintaining a low cost of production.

In an embodiment of the method, the separation step is preceded by a beam splitting step comprising splitting the forward multiple beam into a main forward multiple beam and a secondary forward multiple beam, the measurement step comprising measuring the laser power of each individual beam by means of a photo detector placed at the edge of the secondary forward multiple beam in the vignetting region.

In an alternative embodiment of the method, the separation step comprises placing an imaging lens in the forward multiple beam after the collimator lens and an array of photo detectors such that a corresponding photo detector is placed in the image point of each laser diode from the laser diode array, the measurement step comprising measuring the laser power of each individual beam by means of the corresponding photo detector. Said alternative embodiment is highly suitable for handling multiple beams comprising more than two individual beams.

In an embodiment of the method, the separation step comprises temporal separation of the individual beams. In an advantageous embodiment, the measurement step comprising measuring the laser power of an individual beam by means of a detection system placed in the path of the forward multiple beam, the detection system comprising a photo detector for measuring the laser power and switching means arranged such that the photo detector measures only in the time periods when a single diode laser from the diode laser array is emitting. The measurement laser power of a laser diode from the laser array may advantageously correspond to averaging over of period of time. Such embodiment carries the advantage that the optical light path is unmodified; therefore the costs of productions are low as no additional optical elements are required.

In an embodiment of the method, the measurement step further comprises sampling at pre-determined time intervals the average laser power and information with respect to the laser diodes from the laser diode array which emit light and extracting from the sampled laser powers and the sampled information the average laser power of the individual beam generated by each laser diode.

The invention also relates to a method for automatic power control for the laser power of a forward multiple beam generated by a laser diode array wherein the measurement of the individual laser power of each laser diode from the laser diode array is performed according to a method for measuring the laser power according to invention.

The invention also relates to a method for recording an optical disc, wherein the automatic power control during recording being performed according to a method according to the invention.

The invention also relates to an optical pick-up unit and an optical scanning apparatus for scanning an optical disc incorporating an optical pick-up unit according to the invention.

These and other aspects of the invention are apparent from and will be explained with reference to the embodiments described hereinafter.

### BRIEF DESCRIPTION OF THE DRAWINGS

The features and advantages of the invention will be appreciated upon reference to the following drawings, in which:

FIG. 1 illustrates a schematically an optical scanning apparatus wherein the invention may be practiced;

FIG. 2 illustrates schematically the light path in an optical pick-up unit of an optical scanning apparatus;

FIG. 3 illustrates schematically elements of an optical pick-up unit according to a first embodiment of the invention;

FIG. 4 illustrates schematically elements of an optical pick-up unit according to a second embodiment of the invention;

FIGS. 5a and 5b illustrates schematically the positioning of the photo detectors with respect to the individual laser beams according to two embodiments of the invention;

FIG. 6 illustrates schematically an automated power control loop (APC) according to a third embodiment of the invention;

FIG. 7 illustrates schematically a method of measuring the laser power of each beam according to an embodiment of the invention;

FIG. 8 illustrates a method of performing automatic power calibration according to the invention.

### DETAILED DESCRIPTION OF THE PREFERRED EMBODIMENTS

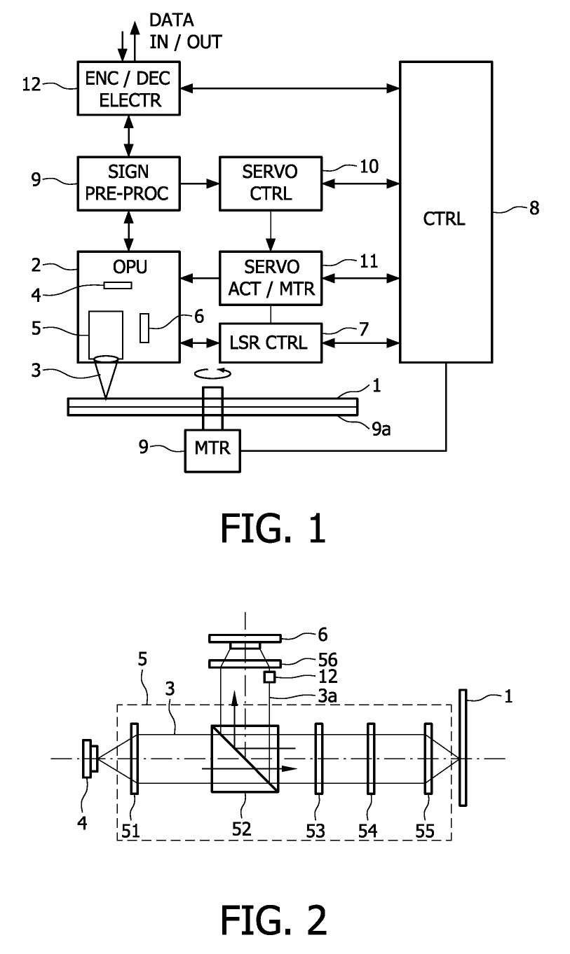

A block diagram of a optical scanning apparatus wherein the invention may be practiced is shown in FIG. 1. An optical disc (1), placed on a turntable (9), is rotated by a turntable motor (9a). The rotation velocity of the turntable motor (9a) is controlled by a controller (8). Encoded information is either read from or recorded there onto the optical disc (1) by means of an Optical Pick-up Unit (OPU) (2). The Optical Pick-up Unit (2) generates and focuses an electromagnetic beam (3) onto the optical disc and it receives a reflected electromagnetic beam which is modulated by a data structure on the optical disc (1). The Optical Pick-up Unit (OPU) (2) comprises, among others components, means (4) for generating the electromagnetic beam (3), a lens system (5) for focusing the beam on the disc, and a main detection system (6) comprising several photodiodes for transforming the received reflected electromagnetic beam into electrical signals. The output power of the electromagnetic beam is controlled by a laser controller (7), which on its turn is controlled by a general controller (8), usually also comprising a digital signal processor (DSP). The electrical signals generated by the main detection system (6) are further processed by a signal pre-processing unit (9). Pre-processed signals are passed to an encoder-decoder unit than encodes/decodes the signals into digital data signals, by making use of known modulation schemes and error correction algorithms.

Fine displacement of the lens system (5) along the axial and the radial direction and coarse displacement of the whole Optical Pick-up Unit (OPU) (2) with respect to the optical disc (1) is controlled by a servo unit (10). The servo unit (10) receives the pre-processed servo signals from the signal pre-processing unit (9) and is controlled by the controller (8).

Further details of the Optical Pick-up Unit (OPU) (2) will be discussed with reference to FIG. 2. Throughout the figures, when the same functional element appears in several figures, the same reference numeral is used to simplify understanding. The embodiment of the lens system (5) described herein after is similar to that used for a Blu-ray (BD) optical disc drives. Other alternative embodiments, for example corresponding for example to CD and DVD optical disc drives, are known in the art.

The means (4) for generating the electromagnetic beam (3) correspond for example to a semiconductor laser comprising an array of laser diodes, each laser being independently controllable and generating an individual laser beam. For simplicity, only one beam is illustrated in FIG. 2. The divergent multiple beam (3) generated by the laser diode array (4) is collimated by a collimator lens (51). The beam may also pass through a beam shaper or a pre-collimator (not shown in the figure), either of the two or the collimator lens also acting as a first field stop. The beam passes next through a polarizing beam splitter (52). Further, the multiple beam is passed through an optical element for removing spherical aberrations (53) a quarter wavelength (λ/4) element (54) for changing the polarization state and an objective lens (55) for focusing the multiple beam onto multiple spots in an information layer of the optical disc (1). The reflected multiple beam passes through the objective lens (55), the quarter wavelength (λ/4) element (54) and the optical element (53) for removing spherical aberrations (53). The reflected multiple beam (3a) is reflected by the polarizing beam splitter (52) towards the main detection system (6). A lens (56) focuses the multiple beam on the main detection system (6).

In a known optical scanning apparatus, a single forward sense diode (12) would be present for collecting part of reflected multiple beam (3a) and measuring the average laser power. The measured laser power by the forward sense diode (13) is used by the laser controller (7) as a feedback signal for generating an automated power control loop (APC) for controlling the means (4) for generating the electromagnetic beam (3). However, this solution is not suitable when using a semiconductor laser comprising a plurality of individually controllable laser diodes, due to presence of thermal cross-talk between the laser diodes leading to offsets in the output powers of the laser diodes. For instance when one laser of the multi-diode semiconductor laser is operating at a high laser output power for writing and a second laser of the multi-diode semiconductor laser is switched on, then the output power of the first laser diode changes. This change in power is unwanted during recording as it affects the quality of the recording, for example by increasing the jitter by affecting the length of the marks.

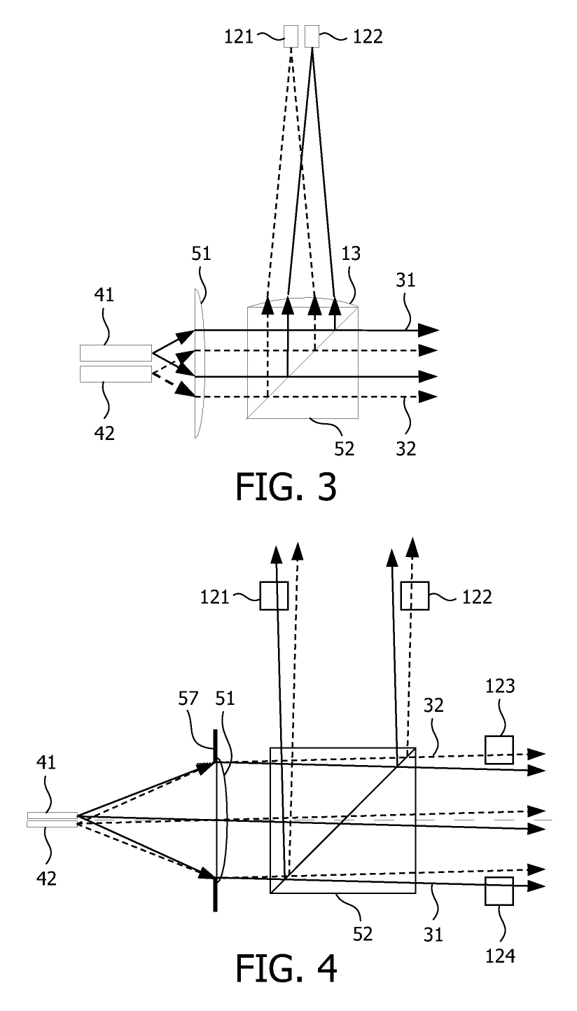

FIG. 3 illustrates schematically elements of an optical pick-up unit according to a first embodiment of the invention. This embodiment is based on the idea that separate detection the laser power of each beam from a coming from a multiple laser beam can be done by spatial filtering.

The laser diodes 41 and 42 generating the individual beam are spaced from each other at a distances in the order of magnitude of 100 μm or less on the semiconductor laser die, meaning that the individual beams will overlap significantly in the light path. Moreover, the amount of thermal cross-talk scales inversely proportional with the spacing between the individual laser diodes. In an embodiment of the invention, an imaging lens (13) is placed behind the beam splitter (52) such that each laser diode (41,42) is imaged onto a corresponding forward sense diode (121, 122). In an embodiment the imaging lens (13) could be integrated into the folding mirror or beam splitter. The forward sense diodes (121, 122) are placed in the focal plane of the imaging lens (13). The focused spots of the individual laser beams are well separated and can be independently detected by the forward sense diodes (121, 122). For simplicity, in FIG. 3 a schematically light path is shown comprising only two laser beams, but the idea is also applicable to systems comprising more than two laser diodes, by means of proper scaling of the optical elements and suitable positioning of the corresponding forward sense diodes (121, 122).

FIG. 4 illustrates schematically elements of an optical pick-up unit according to a second embodiment of the invention. This embodiment is also based on the idea of spatial filtering, as it uses the vignetting of the individual beams for spatial separation.

Before the first field stop (57) the individual beams generated by the laser diodes (41, 42) overlap completely. In an optical pick-up unit (OPU) the size of the first field stop may, depending on the actual design, be determined by a beam shaper or pre-collimator (not illustrated in the drawings) instead of the collimating lens. During propagation after this field stop the individual beams will de-center due to a difference in propagation angle. The laser power can then be detected by collecting light from the edges of the individual beams, in the vignetting regions where the beams do not overlap anymore. The forward sense diodes could be placed after the beam splitter (52), as indicated in FIG. 4 by the forward sense diodes 121 and 122 or, alternatively, in the forward light path as indicated in FIG. 4 by the forward sense diodes 123 and 124.

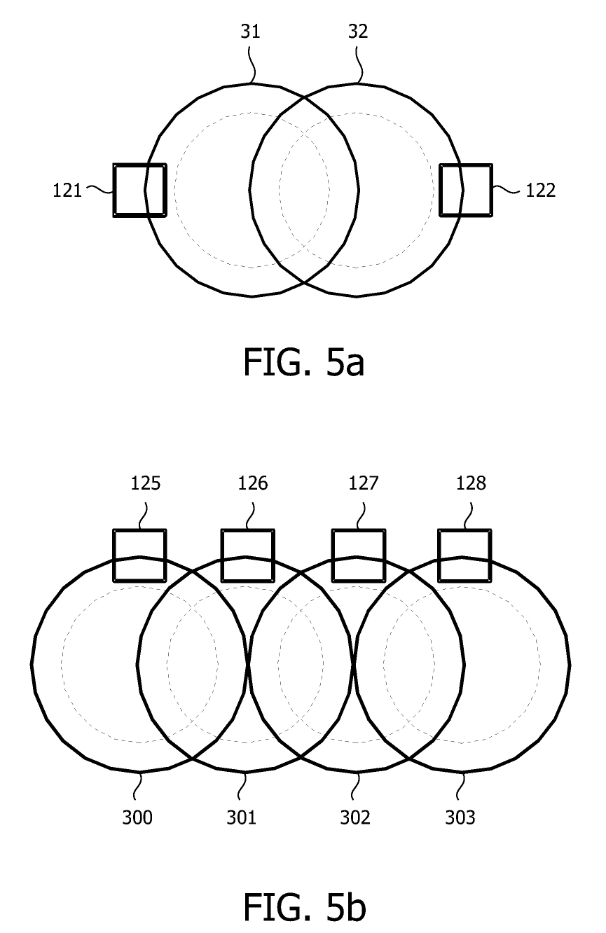

FIGS. 5a and 5b illustrates schematically the positioning of the photo detectors with respect to the individual laser beams according to two embodiments of the invention. FIG. 5a shows schematically the cross section of multiple beam comprising two individual beams (31,32). The forward sense diodes (121, 122) used for detection are placed at the edges of the two individual beams (31,32). The diameter of the beam that is actually used for scanning is smaller, i.e., the field stop at the objective lens is smaller than the first field stop. Hence, the positioning of the forward sense diodes 121 and 122 in the vignetting region after the first field stop does not affect the rest of the optical path, therefore do not influence reading and/or recording of optical discs.

Extension to multiple beams is possible by changing the detector configuration in order to detect all the laser beams separately. By way of example, FIG. 5b illustrates such as an extension to four independent beams (300,301,302,303) and four forward sense diodes (125, 126, 127, 128). The arrangement of FIG. 5b is easily extendable to any number of individual beams.

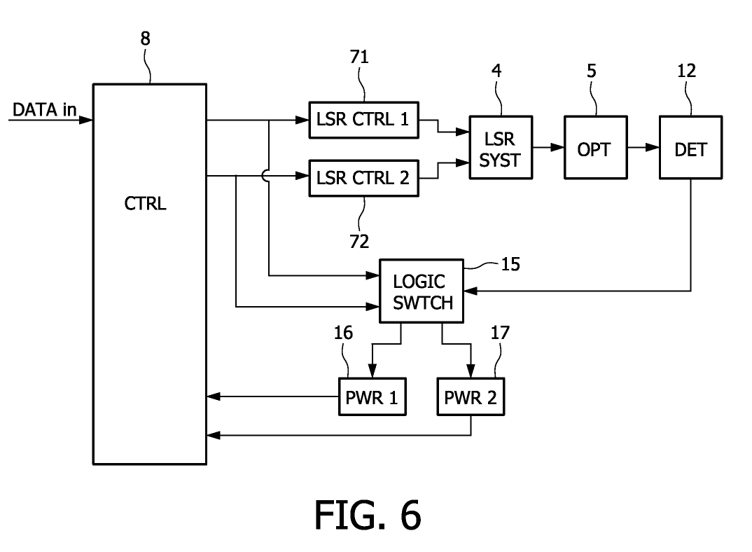

FIG. 6 illustrates schematically illustrates schematically an automated power control loop (APC) according to a third embodiment of the invention. The third embodiment is based on the idea that separation of the multiple beam into individual beams so that the laser power of each beam can be measured independently can be obtained by filtering in the time domain.

In order to record information onto an optical disc, a series of bit streams generated by the encoder/decoder electronics (12) are used. The generation of the individual beams is controlled via the general controller (8) and the laser controller (71, 72) for each of the individual lasers diodes form the multiple laser array (4). Hence information is available for each moment of time about which laser diode is active or not. According to the invention a single detector 12, for example a forward sense diode, is placed in the optical path of the optical system (5) in the region where the individual beam overlap. The data signals coming from the single detector 12 is sampled at pre-determined time intervals preferably corresponding to the time length of a single bit. A logic circuit (15) allows sampling of the data only if one of the laser diodes was active.

Table 1 gives an overview of possible laser diode on/off combinations for a two laser diode system.

TABLE 1

| Laser 1 | Laser 2 | Measurement |
|---|---|---|
| 0 | 0 | Neither lasers |
| 0 | 1 | Laser 2 |
| 1 | 0 | Laser 1 |
| 1 | 1 | Both lasers |

“0” stands for laser off and “1” stands for laser on. Only when one of the lasers is on the measurement of the power detector is used for calibration of the laser power.

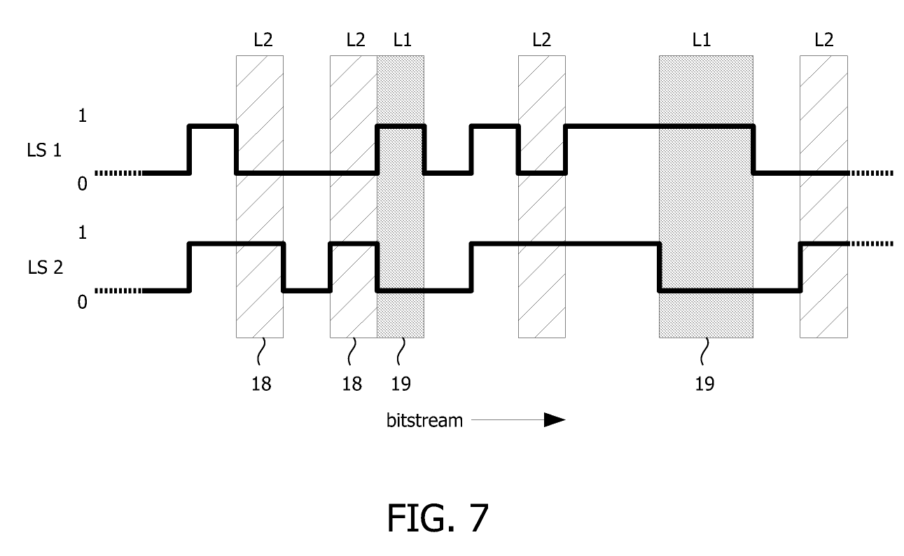

Further details with respect to the functioning of the logic circuit (15) will be given with reference to FIG. 7. Herein depicted are two bit streams as function of time, as they are generated by the encoder decoder unit that are used to control the two lasers L1 and L2. The hashed regions 18 and respectively 19, indicate the periods of time when only one of the lasers (L1 for region 19 or L2 for region 18) is active.

Returning to FIG. 6, the output of the detector 12 in each of these periods 18 and 19 are sent to a corresponding power monitoring circuit 16 and 17, respectively. The power monitoring circuit may average the measured laser power for a pre-determined period of time. The chance that only one laser is on at a certain moment in a multi-laser system depends on the number of lasers N like: N/2^{N}. This chance becomes smaller for larger number of lasers reducing the number of measurements per laser in a given time interval. However, the power fluctuations due to thermal cross-talk between individual laser diodes that needs to be corrected are slower (characteristic time being in the order of milliseconds), while the frequency of “single-laser-on” occurrences, corresponding to the shortest mark to be recorded is much higher (characteristic time in the order of nanoseconds). Consequently, this embodiment of the invention is also applicable to systems comprising a large number of individual beams.

The logical circuit can be implemented either in hardware, for example by means of logical XOR gates on the input data to generate a logical signal that only one laser is on. In an alternative embodiment, the logical circuit can be integrated into the controller 8, usually comprising a digital signal processor, by means of suitable firmware.

An advantage of the third embodiment of the invention is that only one detector is needed, you can also use conventional, simple optics like integrated plastic lens, etc.

In a fourth embodiment of the invention, the signal generated by the detector 12 is averaged for a pre-determined period of time corresponding to several data bits in the individual bit streams LS1 and LS2. The bits in each individual stream are added, for example by means of adder circuits. The averaged signal output and the count value for each bit stream (LS1, LS2) are stored as an entry within a buffer. The process is repeated for a number of pre-determined periods, in each period a new entry being stored within the buffer.

For entry N in the buffer, the average signal (Ave_Signal) generated by detector 12 is related to the output power of laser 1 (Power_LS1), the count value in bitstream LS1 (Count_LS1), the output power of laser 2 (Power_LS2) and the count value in bitstream LS2 (Count_LS2) according to the following equation:

Ave_Signal[entry_{—}N]=Power_{—}LS1*Count_{—}LS1[entry_{—}N]+Power_{—}LS2*Count_{—}LS2[entry_{—}N]

By using a proper algorithm, for example a least square algorithm, the power output of each laser (Power_LS1, Power_LS2) can be calculated. Preferably the number of bits used for averaging is smaller than the distance of the DC control parity bits, otherwise the equation will be less well defined. Also the time of averaging should be sufficiently smaller than the time of thermal fluctuations, so as to assume that Power_LS1 and Power_LS2 are constant.

In an alternative embodiment, the averaging over a pre-determined period of time may be replaced by sampling. With respect to implementation, the invention may be implementing by means of known electronics (counters, adders, memory buffer, logic circuits) or suitable firmware running in a digital signal processor.

Although it has been described for a two-beam system, the fourth embodiment of the invention is applicable to multi-beam system comprising any number of individual beams. The same advantage as in the third embodiment is applicable, that is only one forward sense diode is required and simple optics can be used. Furthermore the advantage of this embodiment is that as detector does not need to measure the power corresponding to separate bits, the speed requirements for the electronics are reduced.

According to an alternative embodiment of the invention, a power calibration array may be created, wherein each element of the array lists the measure output power as a function of the individual value of each bits in the individual bit streams. The cross-talk between the individual diode lasers is incorporated in this power calibration array. Consequently it can be used for independently calibrating the output power of each laser diode, such that a change in output power of one laser due to a change of output power of another laser can be compensated.

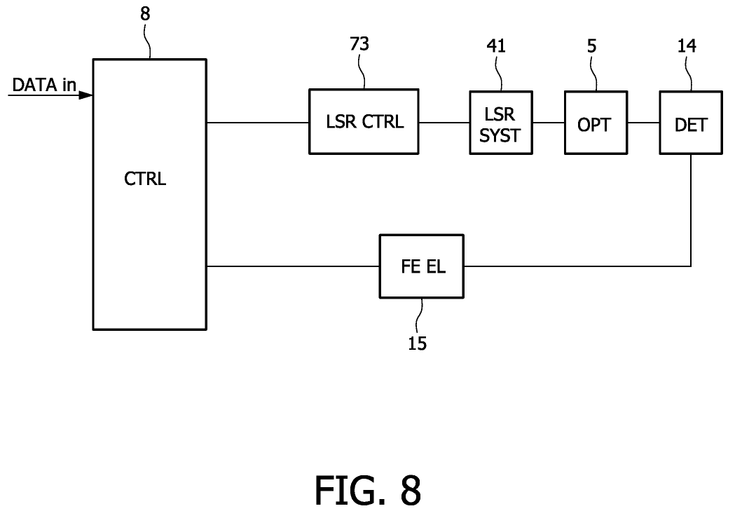

FIG. 8 illustrates a method of performing automatic power calibration according to the invention.

Each individual laser diode 41 from the semiconductor laser comprising the laser array 4 is provided with an independent laser controller (73) which may control, for example the excitation current through the laser diode. The output power of the individual laser diode is detected according to the invention, by means of the optical systems 5, comprising the separation means for separating an individual beam, and power detecting system 14 for measuring the output power of the individual laser diode 41. The signal generated by power detecting system 14 may be further proceeded by front-end electronics, for example by amplifying the signal. The signal is then used as a feedback signal to adjust the output power via the controller and independent laser controller (73). The adjustment of output power is performed continuously by means of the feedback loop. A separate feedback loop is provided for individual laser diode from the semiconductor laser comprising the laser diode array.

In a method for recording an optical disc according to the invention, the automatic power control for the generated multi-beam comprises maintaining a automatic power control feedback loop for each individual laser.

It should be noted that the above-mentioned embodiments are meant to illustrate rather than limit the invention. And that those skilled in the art will be able to design many alternative embodiments without departing from the scope of the appended claims. In the claims, any reference signs placed between parentheses shall not be construed as limiting the claim. Use of the verbs “comprise” and “include” and their conjugations do not exclude the presence of elements or steps other than those stated in a claim. The article “a” or an” preceding an element does not exclude the presence of a plurality of such elements. The invention may be implemented by means of hardware comprising several distinct elements and/or by means of a suitable firmware. In a system/device/apparatus claim enumerating several means, several of these means may be embodied by one and the same item of hardware or software. The mere fact that certain measures are recited in mutually different dependent claims does not indicate that a combination of these measures cannot be used to advantage.

1. A method for measuring the laser power of a forward multiple beam generated by a laser diode array comprising at least two laser diodes, the method comprising:
a generation step, comprising generating the forward multiple beam, the method characterized by
a separation step, comprising separating at least part of the forward multiple beam into individual beams, the number of individual beams being equal to the number of laser diodes in the laser diode array, the arrangement being such that each individual beam comprises light originating from a single laser diode;
a measurement step, comprising measuring the laser power of the each of the individual beams.

2. A method according to claim 1, characterized by the separation step comprising spatial separation of the individual beams.

3. A method according to claim 2, characterized by further comprising:
a beam-shaping step following the generation step, comprising passing the forward multiple beam through an optical element generating a first field stop;
the measurement step comprising measuring the laser power of each individual beam by means of a photo detector placed at the edge of the forward multiple beam in a vignetting region after the first field stop where the individual beams do not overlap, each photo detector thereby receiving light from a single laser diode.

4. A method according to claim 3, characterized by further comprising:
a beam splitting step following the beam-shaping step, comprising splitting the forward multiple beam into a main forward multiple beam and a secondary forward multiple beam,
the measurement step comprising measuring the laser power of each individual beam by means of a photo detector placed at the edge of the secondary forward multiple beam in the vignetting region after the beam splitter where the individual beam do not overlap, each photo detector thereby receiving light from a single laser diode.

5. A method according to claim 2, characterized by further comprising:
a collimation step following the generation step, comprising passing the forward multiple beam through a collimator lens, the collimator lens being placed such that the laser diode array is substantially in the focal point of the collimator lens;
an imaging step, comprising placing an imaging lens in the forward multiple beam after the collimator lens and an array of photo detectors such that a corresponding photo detector is placed in the image point of each laser diode from the laser diode array,
the measurement step comprising measuring the laser power of each individual beam by means of the corresponding photo detector.

6. A method according to claim 5, characterized by further comprising:
a beam splitting step following the collimation step and before the imaging step, comprising splitting the forward multiple beam into a main multiple forward beam and a secondary multiple forward beam,
the imaging lens being placed in the path of the secondary multiple forward beam.

7. A method according to claim 1, characterized by the separation step comprising temporal separation of the individual beams.

8. A method according to claim 7, characterized by the measurement step comprising measuring the laser power of an individual beam by means of a detection system placed in the path of the forward multiple beam, the detection system comprising a photo detector for measuring the laser power and switching means arranged such that the photo detector measures only in the time periods when a single diode laser from the diode laser array is emitting;

9. A method according to claim 7, characterized by further averaging over a predetermined period of time the measured laser power of a laser diode from the laser array.

10. A method according to claim 7, characterized by the measurement step further comprising:
sampling at pre-determined time intervals the average laser power and information with respect to the laser diodes from the laser diode array which emit light;
extracting from the sampled laser powers and the sampled information the average laser power of the individual beam generated by each laser diode.

11. A method according to claim 7, characterized by
a collimation step following the generation step, comprising passing the forward multiple beam through a collimator lens, the collimator lens being placed such that the laser diode array is in the focal point of the collimator lens;
a beam splitting step following the collimation step, comprising splitting the forward multiple beam into a main multiple forward beam and a secondary multiple forward beam,
the detection system being place in the path of the secondary multiple forward beam.

12. A method for automatic power control for a laser power of a forward multiple beam generated by a laser diode array comprising at least two laser diodes, the method comprising:
setting a desired output laser power for a pre-selected laser diode from the laser diode array;
measuring the laser power of the pre-selected laser diode;
controlling the individual laser power of the pre-selected laser diode by means of a feedback control loop based on the desired output laser power and the measured individual laser power;
the method characterized by the individual laser power being measured according to a method for measuring the laser power according to claim 1.

13. A method for recording an optical disc comprising performing automatic power control for a laser power of a forward multiple beam generated by a laser diode array comprising at according to the method of claim 12.

14. An optical pick-up unit (OPU) comprising:
a laser diode array comprising at least two laser diodes for generating a multiple laser beam;
a power detection system for measuring laser power;
the optical pick-up unit (OPU) characterized that it further comprises:
separation means for separating at least part of the forward multiple beam into individual beams, the number of individual beams being equal to the number of laser diodes in the laser diode array, the separation means being adapted such that each individual beam comprises light originating from a single laser diode;
the power detection system being adapted to measure the laser power of each individual beam.

15. An optical pick-up unit (OPU) according to claim 14, characterized in that the separation means are adapted to separate the individual beams in space.

16. An optical pick-up unit (OPU) according to claim 15, characterized in that it further comprises:
means for creating a first field stop, the first field stop preceding the separation means in the optical light path;
the power detection system comprising at least two photo detectors placed at the edge of the forward multiple beam in a vignetting region after the first field stop where the individual beams do not overlap, each photo detector thereby receiving light from a single laser diode.

17. An optical pick-up unit (OPU) according to claim 16, characterized in that it further comprises:
a beam splitter for splitting the forward multiple beam into a main forward multiple beam and a secondary forward multiple beam,
the photo detectors being placed at the edge of the secondary forward multiple beam in the vignetting region after the beam splitter where the individual beam do not overlap, each photo detector thereby receiving light from a single laser diode.

18. An optical pick-up unit (OPU) according to claim 15, characterized in that it further comprises:
a collimator lens being placed such that the laser diode array is substantially in the focal point of the collimator lens;
an imaging lens placed in the path of the forward multiple beam after the collimator lens;
the power detection system comprising an array of photo detectors such that a corresponding photo detector for the laser power is placed in the image point of each laser diode from the laser diode array.

19. An optical pick-up unit (OPU) according to claim 15, characterized in that it further comprises:
a beam splitter for splitting the forward multiple beam into a main forward multiple beam and a secondary forward multiple beam,
the imaging lens being placed in the path of the secondary multiple forward beam.

20. An optical pick-up unit (OPU) according to claim 13, characterized in that the separation means are adapted to separate the individual beams in time.

21. An optical pick-up unit (OPU) according to claim 20, characterized in that
the power detection system comprises a photo detector for measuring the laser power and switching means arranged such that the photo detector is enabled to measure only in the time periods when a single diode laser from the diode laser array is emitting.

22. An optical pick-up unit (OPU) according to claim 21, characterized in that the power detection system is enabled to averaging over a predetermined period of time the measured laser power of a laser diode from the laser array.

23. An optical pick-up unit (OPU) according to claim 22, characterized in that the power detection system is further enabled to measure the average laser power at pre-determined time intervals and the optical pick-up unit (OPU) further comprises:
means for generating corresponding information with respect to the laser diodes from the laser diode array generating light for the predetermined time intervals when the detection system is measuring;
means for extracting from the sampled laser powers and the generated information the average laser power of the individual beam generated by each laser diode.

24. An optical pick-up unit (OPU) according to claim 21, characterized in that it further comprises:
a collimator lens being placed such that the laser diode array is in the focal point of the collimator lens;
a beam splitter for splitting the forward multiple beam into a main multiple forward beam and a secondary multiple forward beam,
the power detection system being place in the path of the secondary multiple forward beam.

25. An optical scanning apparatus comprising an optical pick-up unit according to claim 13.
